(19) United States
(12) Patent Application Publication
(10) Pub. No.: US 2001/0032313 A1
(43) Pub. Date: Oct. 18, 2001

(54) Embedding a watermark in an information signal

(76) Inventors: Jaap Andre Haitsma, Eindhoven (NL); Antonius Adrianus Cornelis Maria Kalker, Eindhoven (NL)

Correspondence Address: Corporate Patent Counsel, U.S. Philips Corporation, 580 White Plains Road, Tarrytown, NY, 10591, US

(21) Appl. No.: 09/772,482

(22) Filed: Jan. 29, 2001

(30) Foreign Application Priority Data
Feb. 1, 2000 (EP) 00200328.3

(51) Int. Cl. H04L 9/00; H04L 9/32; G06F 11/30; G06F 12/14

(52) U.S. Cl. 713/176; 713/193

(57) ABSTRACT

Disclosed is a method and an arrangement for embedding a watermark in an information signal, in particular an audio signal. The method is based on modification of the magnitude (not the phase) of Fourier coefficients and does not require the original signal for detection. The embedder divides (10) the signal into frames of a given length, and subjects each frame to a Fast Fourier Transform (11). The Fourier coefficients X(k) are modified (20,21) as a function of a predetermined secret watermark W. A payload (P) is encoded in the embedded watermark by cyclically shifting (41) the watermark W by a number (v) of samples representing said payload.

### FIELD OF THE INVENTION

The invention relates to a method and an arrangement for embedding a watermark in an information signal, in particular an audio signal. The invention also relates to a method and an arrangement for detecting a watermark in such an information signal.

### BACKGROUND OF THE INVENTION

In recent years there has been a clear trend toward digitization of audio signals. Digital audio has many advantages over analog audio, such as easy access, efficient storage and transmission and the ability to make perfect digital copies. However, the ability to make perfect digital copies is considered a major threat to record companies as they fear an uncontrollable increase in the spread of illegal copies. The emergence of CD recorders and MP3 sites on the Internet does not help in lessening that fear.

Digital watermarking is an emerging technology that can be used for ownership verification, broadcast-monitoring and copy and playback control. A watermark is an imperceptible label which is embedded in the information signal by slightly modifying the signal samples. The watermarking scheme should be designed in such a way that it can still be reliably detected after signal-processing operations. In the field of audio, examples of such processing operations are compression, cropping, D/A and A/D conversion, equalization, temporal scaling, group delay distortions, filtering, and removal or insertion of samples.

Though many schemes on watermarking of still images and video have been published, there is relatively little literature on audio watermarking. Most of the techniques which have been published resemble image watermarking techniques. Image watermarking techniques often hide a noisy watermark pattern in the pixel domain, which corresponds to the time domain for audio signals. Various aspects of such watermark embedding and detection methods are disclosed in Applicant's International Patent Applications WO-A-99/45705, WO-A-99/45706, and WO-A-99/45707. Another known audio watermarking scheme exploits echo-hiding. This technique entails embedding multiple and imperceptible echoes of the cover signal with specific delays.

### OBJECT AND SUMMARY OF THE INVENTION

It is an object of the invention to provide a method of embedding a watermark in an information signal (particularly but not exclusively an audio signal), which is robust against the above mentioned processing operations and allows an embedded watermark to be detected in a suspect signal without requiring the original signal to be available.

To this end, the invention provides a method of embedding a watermark in an information signal, comprising the steps of:

generating a series of watermark samples representing the watermark;

dividing the information signal into frames of a given length;

Fourier transforming the frames into series of coefficients;

modifying the magnitudes of said coefficients as a function of the watermark samples, while leaving the phase of the coefficients substantially unchanged; and

inverse transforming the series of modified coefficients into modified signal frames.

The invention is based on the recognition that the human auditory system is insensitive to absolute phase, and that audio signal modifications by group-delay distortions have little or no impact on the perceived quality. This is contrary to image and video content for which phase plays a much larger perceptual role. The watermarking scheme based on modifying absolute values of Fourier coefficients is also inherently invariant to delays. The relative position of the frames along the time axis is therefore not relevant. As a consequence, the division of the suspect signal into frames at the receiver end does not necessarily have to correspond to the division of the original signal at the transmitter end. There is no need for synchronization.

In an advantageous embodiment, the modifying step includes multiplicatively adding each watermark sample to the corresponding Fourier coefficient. The expression “multiplicatively adding” herein means multiplying the coefficients by a scalar 1+a (where |a|<<1 in practice). This operation does not affect the phase of a coefficient and is easy to implement in practical systems.

A significant advantage of the watermarking scheme is that it allows embedding multi-bit payload data in a simple yet effective and easy-to-detect manner. To this end, an embodiment of the method comprises the steps of cyclically shifting the series of watermark samples by an amount representing the payload data, and modifying the magnitudes of the coefficients as a function of the shifted watermark samples.

### BRIEF DESCRIPTION OF THE DRAWINGS

FIGS. 1 and 2 show schematic diagrams of arrangements for embedding a watermark in accordance with the invention.

FIG. 3 shows a schematic diagram of an arrangement for detecting a watermark in an information signal.

FIG. 4 shows a schematic diagram of an arrangement for embedding a multi-bit payload in an information signal.

FIG. 5 shows a schematic diagram of an arrangement for detecting a multi-bit payload in an information signal.

FIG. 6 shows a diagram to illustrate the operation of the arrangement which is shown in FIG. 5.

### DESCRIPTION OF PREFERRED EMBODIMENTS

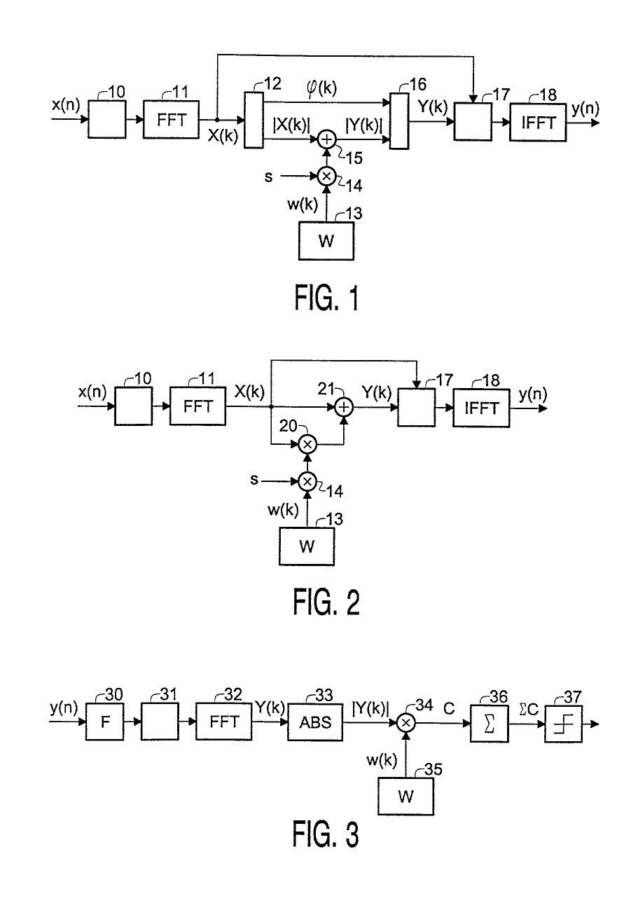

FIG. 1 shows a schematic diagram of an arrangement for embedding a watermark in accordance with the invention. The embedding process is performed on a frame-by-frame basis. To this end, the arrangement comprises a division circuit 10 which divides the incoming digital audio signal x(n) into frames of 2048 audio signal samples. The frame length is a tradeoff between detection performance and audibility. A large frame length is desired for detection robustness. A short frame length is desired to better adapt the embedding to local properties of the audio signal.

The frames of 2048 audio samples are applied to a Fast Fourier Transform circuit 11. Each frame is thereby transformed into a series of 2048 Fourier coefficients X(k). As is generally known in the field of mathematics, the Fourier coefficients occur in pairs. Each pair comprises a complex number representing a positive frequency, and its conjugate representing a negative frequency. Further operations are therefore applied to 1024 Fourier coefficients. In view thereof, the index k will hereinafter also be assumed to have the range [0 . . . 1023]. A magnitude and phase calculation circuit 12 determines the magnitude or absolute value |X(k)| and the phase φ(k) of the coefficients.

The arrangement further comprises a memory 13 in which a secret watermark W is stored in the form of 1024 watermark samples w(k). The memory is preferably a read-only memory which cannot be interrogated. The watermark W is a noise pattern. The samples w(k) are drawn from a normal distribution with mean 0 and standard deviation 1. The watermark W is multiplied (14) by a global scaling factor s, which determines the tradeoff between robustness and audibility of the watermark. The scaled watermark samples sw(k) are subsequently added (15) to the corresponding coefficient magnitude |X(k)| so as to generate modified magnitudes |Y(k)|. As FIG. 1 shows, this process of modification leaves the phase φ(k) unaffected.

The modified coefficients |Y(k)| and original phases φ(k) are combined by a reconstruction circuit 16 so as to represent the modified series of Fourier coefficients Y(k) by complex numbers and their respective conjugates. One can easily verify that the power of the modified series of coefficients Y(k) will on average be scaled by a factor of 1+s² by the embedding process. An optional power equalization circuit 17 in the arrangement re-scales the watermarked Fourier coefficients Y(k) to such an extent that the power of the original coefficients X(k) in each series is restored. This optional operation prevents that watermarked content can be distinguished from the original by a power difference. An Inverse Fast Fourier Transform circuit 18, which transforms the modified series of coefficients back to series of 2048 signal samples y(n) in the original time domain, completes the embedding process.

FIG. 2 shows a more practical embodiment of the embedder, which is easier to implement. The same reference numerals are used to denote the same functions or circuits as in FIG. 1. The watermarked Fourier coefficients Y(k) are now obtained by multiplying (20) sw(k) by X(k), and adding (21) the result to X(k). This operation, which is referred to as multiplicative addition, yields:

Y(k)=X(k)[1+sw(k)]

Note that the operation does not affect the phase of X(k), because [1+sw(k)] is a real number.

In a further embodiment of the arrangement, the watermark samples w(k) are not only scaled by the global scaling factor s. Instead thereof (or in addition thereto), the samples are scaled by a factor λ(k), the value of which depends on the index k in accordance with a given model of the human auditive system. Such an arrangement (not shown) embeds the watermark in accordance with:

Y(k)=X(k)[1+sλ(k)w(k)]

FIG. 3 shows a schematic diagram of an arrangement for detecting a watermark in a suspect information signal. To boost the detection performance, the possibly watermarked audio signal y(n) is first decorrelated by an optional decorrelation filter 30. An example of such a filter is the 3 taps FIR filter F:

F=[−1 2 −1]

The (filtered) signal y(n) is applied to a division circuit 31 which divides the incoming digital audio signal x(n) into frames of 2048 audio signal samples. The length of the frames is the same as in the embedder. Note, however, that the position of the frames may be different. There is no need for synchronization between the division circuit 31 and the corresponding division circuit 10 of the embedder. Each frame of signal samples is subjected to an FFT by Fast Fourier Transform circuit 32. As already mentioned above, further operations are applied to 1024 Fourier coefficients Y(k) (k=0 . . . 1023) because the Fourier coefficients occur in conjugate pairs. A magnitude calculation circuit 33 determines the absolute value |Y(k)| of the coefficients.

The arrangement further includes a correlation circuit 34. The correlation circuit calculates for each signal frame the correlation C between the magnitudes |Y(k)| and the corresponding samples w(k) of the watermark pattern W to be detected. In mathematical notation:

$$C = {\sum }_{k = 0}^{1023} w ( k ) \vert Y ( k ) \vert$$

The watermark samples w(k) are retrieved from a memory 35, preferably a read-only memory which cannot be interrogated. An (optional) accumulator 36 accumulates the correlation for a number of successive frames to improve the detection reliability. A comparator 37 compares the accumulated correlation ΣC with a given threshold. If the correlation is larger than the threshold, an output signal is generated to indicate that the suspect audio signal is indeed watermarked with the secret watermark W.

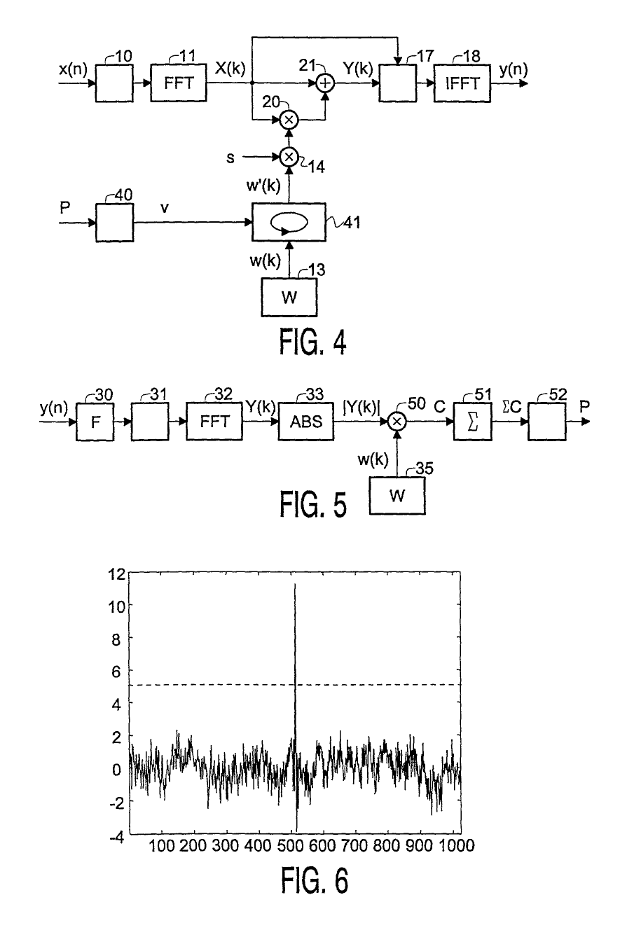

FIG. 4 shows a schematic diagram of an arrangement for embedding a multi-bit payload in an information signal in accordance with a further aspect of the invention. The same reference numerals are used to denote the same functions or circuits as in FIG. 2. The arrangement differs from the embedder, which is shown in FIG. 2, by an input for receiving a multi-bit payload P, a mapping circuit 40, and a cyclic shift circuit 41. The mapping circuit 40 maps the multi-bit payload P onto a shift vector v. In the present example, the payload is a 10-bit code and the shift vector is a number in the range [0 . . . 1023]. The cyclic shift circuit 41 is connected between the watermark memory 13 and the multiplier 14. It cyclically shifts the series of watermark samples w(k) by v. The shifted series of watermark samples is denoted w'(k) in the Figure.

FIG. 5 shows a schematic diagram of the corresponding payload decoder. The same reference numerals are used to denote the same functions or circuits as in FIG. 3. The arrangement differs from the embedder, which is shown in FIG. 3, in that a correlation circuit 50 calculates the correlation CV for each possible shift vector v. The correlation circuit thus generates a series C of correlation values C₀ . . . C₁₀₂₃. In a preferred embodiment of the payload detector, the correlation is actually done in the Fourier domain of the signal |Y| using Symmetrical Phase Only Matched Filtering (SPOMF). More particularly, the peak pattern C is obtained by calculating:

C=IFFT(phaseOnly(FFT(|Y|)phaseOnly(FFT(W)*))

where phaseOnly(x)=x/|x| for x#0 and phaseOnly(0)=1. A more detailed description of SPOMF can be found in Applicant's International Patent Application WO-A-99/45707.

A signal that has been watermarked with the watermark W being shifted over v samples (as compared with the unshifted watermark W being applied to correlator 50) exhibits a sharp peak. In view thereof, the series of correlation values C₀ . . . C₁₀₂₃ is also referred to as a peak pattern. FIG. 6 shows a practical example of such a peak pattern for v=512. In this example, the vertical axis denotes the detection reliability in standard deviations. A dashed line for the standard deviation value 5 represents a threshold for a correlation value to be a peak. A payload decoder 52 retrieves the shift vector v from said peak pattern and decodes the payload P. An (optional) accumulator 51, which accumulates the peak patterns of a number of frames, improves the robustness of payload retrieval. The payload capacity can be further increased by embedding a plurality of watermark patterns with different shifts.

It should be noted that encoding a payload in the shift of a watermark pattern is known per se from International Patent Application WO-A-99/45705, where the watermark is embedded in the pixel domain of an image signal. However, in the prior-art method, the payload is encoded in the relative shift of the watermark with respect to a reference watermark (i.e. a different watermark pattern or the same pattern with a different sign). The present method does not require such a reference watermark to be embedded because the embedding scheme is inherently robust against shifts.

Disclosed is a method and an arrangement for embedding a watermark in an information signal, in particular an audio signal. The method is based on modification of the magnitude (not the phase) of Fourier coefficients and does not require the original signal for detection. The embedder divides (10) the signal into frames of a given length, and subjects each frame to a Fast Fourier Transform (11). The Fourier coefficients X(k) are modified (20,21) as a function of a predetermined secret watermark W. A payload (P) is encoded in the embedded watermark by cyclically shifting (41) the watermark W by a number (v) of samples representing said payload.

1. A method of embedding a watermark in an information signal, comprising the steps of:
generating a series of watermark samples representing the watermark;
dividing the information signal into frames of a given length;
Fourier transforming the frames into series of coefficients;
modifying the magnitudes of said coefficients as a function of the watermark samples, while leaving the phase of the coefficients substantially unchanged; and
inverse transforming the series of modified coefficients into modified signal frames.

2. A method as claimed in claim 1, wherein said modifying step includes multiplicatively adding each watermark sample to the corresponding coefficient.

3. A method as claimed in claim 1, further including the step of weighting the watermark samples using respective weighting factors, said weighting factors being selected in accordance with a given human acoustic model.

4. A method as claimed in any one of claims 1 to 3, further comprising the step of scaling the series of modified coefficients to such an extent that the power of said modified coefficients is substantially equal to the power of the corresponding original coefficients.

5. A method as claimed in claim 1, further comprising the steps of:
receiving payload data;
cyclically shifting the series of watermark samples by an amount representing said payload data;
wherein the step of modifying the magnitudes of the coefficients comprises modifying said magnitudes as a function of the shifted watermark samples.

6. A method of detecting a watermark in an information signal, comprising the steps of:
generating a watermark as a series of watermark samples;
dividing the information signal samples into frames of a given length;
Fourier transforming the frames into series of coefficients;
calculating the magnitude of each coefficient;
determining the correlation between a series of coefficient magnitudes and the series of watermark samples;
generating an indication signal if said correlation exceeds a predetermined threshold.

7. A method as claimed in claim 6, further comprising the step of accumulating said correlation for a number of frames prior to the step of generating the indication signal.

8. A method as claimed in claim 6, wherein said step of determining the correlation comprises determining the correlation between the series of coefficient magnitudes and a plurality of series of watermark samples, each series of watermark samples being a cyclically shifted version of a given series of watermark samples by an amount representing payload data; and further comprising the steps of:
determining the series for which said correlation exceeds a given threshold; and
decoding the corresponding cyclic shift into payload data.

9. An arrangement for embedding a watermark in an information signal, comprising:
means for generating a series of watermark samples representing the watermark;
means for dividing the information signal into frames of a given length;
means for Fourier transforming the frames into series of coefficients;
means for modifying the magnitudes of said coefficients as a function of the watermark samples, while leaving the phase of the coefficients substantially unchanged; and
means for inverse transforming the series of modified coefficients into modified signal frames.

10. An arrangement for detecting a watermark in an information signal, comprising:
means for generating a watermark as a series of watermark samples;
means for dividing the information signal samples into frames of a given length;
means for Fourier transforming the frames into series of coefficients;
means for calculating the magnitude of each coefficient;
means for determining the correlation between a series of coefficient magnitudes and the series of watermark samples;
means for generating an indication signal if said correlation exceeds a predetermined threshold.

11. An information signal having an embedded watermark, characterized in that the information signal has been divided into frames of a given length, the magnitudes of the Fourier coefficients of the series have been modified as a function of a watermark while leaving the phase of the coefficients substantially unchanged, and the series of modified coefficients have been inverse transformed into modified signal frames.

12. A storage medium having recorded thereon an information signal as claimed in claim 11.
